(19) United States
(12) Patent Application Publication
(10) Pub. No.: US 2015/0308178 A1
(43) Pub. Date: Oct. 29, 2015

(54) SENSORS INDICATING FROM WHICH SIDE A BARRIER IS ACCESSED

(71) Applicant: Vivint, Inc., Provo, UT (US)

(72) Inventors: Jeremy B. Warren, Draper, UT (US); Jefferson Lyman, Alpine, UT (US)

(73) Assignee: Vivint, Inc., Provo, UT (US)

(21) Appl. No.: 14/261,235

(22) Filed: Apr. 24, 2014

(51) Int. Cl. E05F 15/70; H04L 12/28; G05B 15/02

(52) U.S. Cl. CPC E05F 15/70; G05B 15/02; H04L 12/2816

(57) ABSTRACT

Methods and systems are described for determining operation of an openable barrier into a building. A method for determining operation of an openable barrier into a building includes confirming that the barrier is closed, wherein the barrier has an exterior side and an interior side. The method also includes determining whether the barrier is operated from the exterior side or the interior side, and controlling a feature of a home automation system based at least in part on the determined operation of the barrier.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of home/business automation and security products. Advancements in mobile devices allow users to monitor and/or control an aspect of a home or business. As automation and security products expand to encompass other systems and functionality in the home or business, opportunities exist for controlling physical access to and determining user activities associated with a property monitored by the automation and security products.

### SUMMARY

Methods and systems are described for determining operation of an openable barrier into a building. According to at least one embodiment, a method for determining operation of an openable barrier into a building includes confirming that the barrier is closed, wherein the barrier having an exterior side and an interior side. The method also includes determining whether the barrier is operated from the exterior side or the interior side, and controlling a feature of a home automation system based at least in part on the determined operation of the barrier.

In one example, the barrier may be one of a door or a window, and operating the barrier includes operating a handle or lock of the barrier. Determining whether the barrier is operated from the exterior side or the interior side may include operating at least one touch sensor. Determining whether the barrier is operated from the exterior side or the interior side may include operating at least one motion sensor. Determining whether the barrier is operated from the exterior side or the interior side may include operating at least one optical sensor. Determining whether the barrier is operated from the exterior side or the interior side may include operating at least one mechanical button or switch. The method may include wirelessly transmitting a sensor signal from the barrier to a controller of the home automation system, and using the sensor signal to determine whether the barrier is operated from the exterior side or the interior side. The method may also include controlling whether the barrier is permitted to open based on whether the barrier is operated from the exterior side or the interior side.

Another embodiment is directed to a sensor assembly for an barrier that is able to be opened, the barrier having an interior side and an exterior side. The sensor assembly includes at least one sensor configured to determine whether the barrier is operated from the interior side or the exterior side, and a wireless transmitter configured to transmit signals from the at least one sensor to an automation and security system. In one example, the at least one sensor includes one of a touch sensor, an optical sensor, a motion sensor, a mechanical button, and a switch.

A further embodiment is directed to an apparatus for determining operation of an openable barrier into a building. The apparatus includes a processor, a memory in electronic communication with the processor, and instructions stored in the memory. The instructions are executable by the processor to collect data from at least one sensor associated with the barrier, and determine using the collected data whether the barrier is operated from an interior side or an exterior side of the building.

In one example, the apparatus may further include at least one handle or lock mounted to the barrier and operable to control opening of the barrier, and the at least one sensor may be configured to determine an operation state of the at least one handle or lock. The at least one sensor may include one of a touch sensor, a motion sensor, an optical sensor, and a mechanical button or switch. The barrier may be a door or a window. The instructions may be executable by the processor to wirelessly transmit signals from the at least one sensor to a control panel of an automation and security system. The instructions may be executable by the processor to control opening of the barrier based on the whether the barrier is operated from the interior side or the exterior side. The instructions may be executable by the processor to generate an alarm if the barrier is operated from one of the interior side or the exterior side during an unauthorized time period. The instructions are executable by the processor to generate an alarm if the barrier is operated from one of the interior side or the exterior side, and bypass generating an alarm if the barrier is operated from the other of the interior side or the exterior side. Determining whether the barrier is operated from an interior side or an exterior side of the building may include determining if a user is touching the barrier. The instructions may be executable by the processor to determine an identity of a user operating the barrier.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an environment in which the present systems and methods may be implemented;

FIG. 2 is a block diagram of another environment in which the present systems and methods may be implemented;

FIG. 3 is a block diagram of another environment in which the present systems and methods may be implemented;

FIG. 4 is a block diagram of another environment in which the present systems and methods may be implemented;

FIG. 5 is a block diagram of another environment in which the present systems and methods may be implemented;

FIG. 6 is a block diagram of an example barrier sensor module for use in the environments shown in FIGS. 1-5;

FIG. 7 is a schematic diagram of a building in which the systems and methods disclosed herein may be implemented;

FIG. 8 is a schematic diagram of a door and other features of the building shown in FIG. 7;

FIG. 9 is schematic diagram of another door and other features of the building shown in FIG. 7;

FIG. 10 is a flow diagram showing steps of an example method in accordance with the present disclosure;

FIG. 11 is a flow diagram showing steps of another example method in accordance with the present disclosure; and

FIG. 12 is a block diagram of a computer system suitable for implementing the systems and methods of FIGS. 1-11.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to home automation and home security, and related security systems and automation for use in commercial and business settings. The automation and security systems and methods disclosed herein may generally be referred to as monitoring systems, may include automation and/or security functionality, and may include systems and methods for use in home and business and/or commercial settings.

The systems and methods described herein relate generally to monitoring operation of a barrier and controlling access through a barrier, such as a door or window. Among other functions, home automation and security systems typically monitor and control access through barriers such as doors and windows. There are number of challenges related to turning ON and OFF the home automation and security system to provide egress into and out of a building at appropriate times to ensure 1) an alarm is not inadvertently generated when an authorized person enters or exits the building (or opens or closes a window or other access point for the building), or 2) an alarm is properly generated when an unauthorized person enters or exits the building. In some cases, the home automation system may be programmed to maintain an ON state at all times in order to alleviate the possibility of inadvertently generating an alarm when an authorized person enters or exits the building, or opens or closes a window or other access point for the building. In such cases, it may be helpful to know whether the person entering, exiting, or otherwise interfacing with an access point to the building is an authorized person (e.g., operating or interfacing with a barrier).

One aspect of the present disclosure relates to systems, methods and related devices for determining whether a door handle, or other device used to control access through an openable barrier into a building, is being operated from the interior or exterior side of the barrier. One or more sensors may be used to determine such access. For example, separate touch sensors may be associated with interior and exterior door handles on a door of a house. The touch sensors may be able to distinguish between the operator operating the interior door handle verses opening the exterior door handle. The touch sensors may include, for example, an electrostatic or magnetic sensor.

In another example, the one or more sensors may include a motion sensor that determines relative motion between features of the door handle, between components of the door handle and features of the door, or of an object directly adjacent to the door. A further example includes at least one optical sensor that determines the presence of a person adjacent to the door handle. The optical sensor may be one example of the motion sensor mentioned above. A still further example includes a mechanical button or switch associated with the handle. The button may be actuated as part of grasping the handle, or may be actuated before or after operating one of the handles to indicate that the handle operation is authorized.

The one or more sensors, buttons or switches may be integrated into a handle assembly, lock or other feature of the barrier. In other embodiments, the sensor, button or switch is an add-on device/system to an existing component of the barrier. The one or more sensors, buttons or switches may be used at any openable barrier for the building, including doors, windows, etc.

The ability to determine whether the barrier is opened from the interior or exterior side may be one of many factors used to determine a pattern of behavior for at least some users of the building. The opening and/or closing function may be associated with a particular person. For example, a person may carry a device that identifies who he/she is (e.g., authentication), and associates the barrier opening with that person. The device may be a cell phone, fob, or other device that is programmable with user identification information. Information about the barrier opening event may be communicated to an automation and/or security system for use in determining the patterns mentioned above, as well as predict activities associated with the building that may occur in the future. Further, information about the barrier opening may be used to control whether the handle remains locked or is automatically unlocked. The automated control of the handle locked state may be overridden based on various factors such as, for example, the person operating the handle, the time of day, or the type of handle/barrier opening.

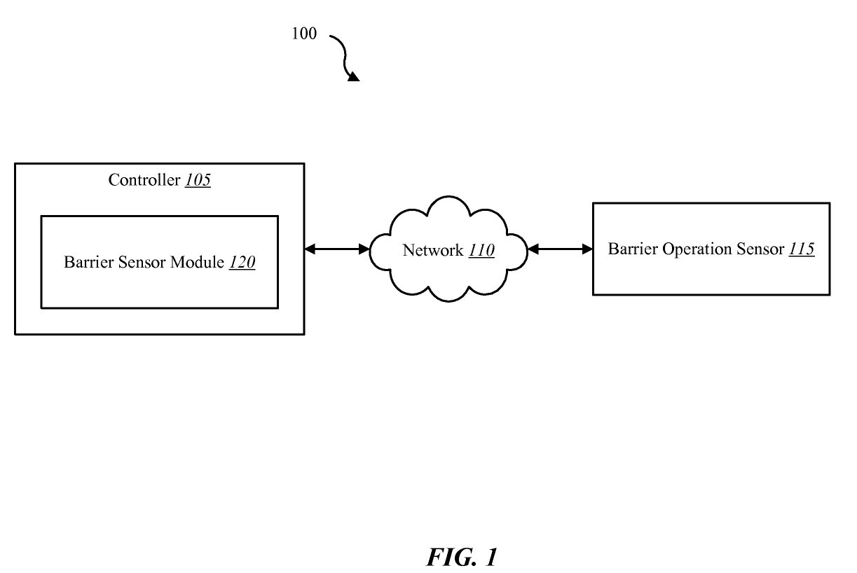

FIG. 1 is a block diagram illustrating one embodiment of an environment 100 in which the present systems and methods may be implemented. In some embodiments, the systems and methods described herein may be performed on or using a controller 105 that communicates with a barrier operation sensor 115 via the network 110. The controller 105 may include a barrier sensor module 120. Barrier operation sensor 115 may generate and transmit information concerning operation of a barrier with which the barrier operation sensor 115 is associated. The sensor signals and/or other information may be transmitted over network 110 to controller 105. Barrier sensor module 120 may determine, at least in part using the information received from barrier operation sensor 115, an operation state of the barrier. The network 110 provides communication via, for example, wired or wireless connections. Further, network 110 may include a plurality of communication mediums.

Barrier operation sensor 115 may include one or more sensors and operate to determine at least one operational parameter or characteristic of a barrier. For example, barrier operation sensor 115 may determine whether a barrier (e.g., a door or a window of a building) is in a closed state or an open state. In another example, barrier operation sensor 115 may determine whether a latch such as a doorknob is in a rest state or in an operation state. In another example, barrier operation sensor 115 may indicate whether a lock mechanism is in a rest state, an operational state, or has, for example, a key inserted therein prior to operation. In a yet further example, barrier operation sensor 115 may determine whether a latch or other portion of a barrier is being touched or that movement is occurring adjacent to the barrier.

In examples wherein barrier operation sensor 115 includes a plurality of different sensors, one sensor may provide one set of information related to the barrier (e.g., an open or closed state of the barrier) and another sensor may indicate a different parameter related to the barrier such as, for example, operation of a latch or lock, touching of a portion of the barrier, or motion adjacent to the barrier. The combination of information provided by the various sensors may be utilized by the barrier sensor module 120 to determine an operation state or condition of the barrier. For example, barrier sensor module 120 may determine from which side the barrier is operated (e.g., on an interior side or an exterior side of the barrier). Information related to which side of a barrier the barrier is being operated may be helpful in deducing other types of information, patterns, etc., that may be used to provide other features and functionality related to, for example, the barrier itself and/or a home automation system within which the controller 105, network 110 and barrier operation sensor 115 operate.

In some examples, environment 100 represents at least a portion of a home automation system. The controller 105 may be part of, for example, a control panel of the home automation system. The barrier operation sensor 115 may be associated with a barrier that provides an access point into the home (e.g., a door or window). Network 110 may include or be part of a wireless network, a wired network, or some combination thereof.

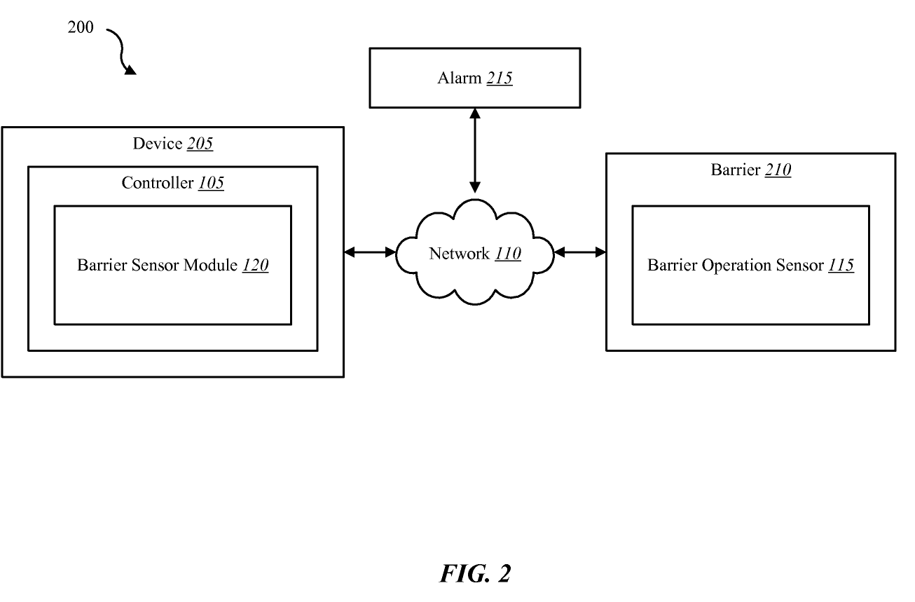

Referring now to FIG. 2, in some embodiments, environment 200 may include the components of environment 100 described above, and may further include a device 205, a barrier 210, and an alarm 215. Device 205 may include or be part of a control panel of a home automation system. Alternatively, device 205 may be a portable electronic device including, for example, a touch screen display. Device 205 may be in communication with one or more sensors. A sensor may include, for example, a camera sensor, an audio sensor, a forced entry sensor, a shock sensor, a proximity sensor, a boundary sensor, an appliance sensor, a light fixture sensor, a temperature sensor, a light beam sensor, a three-dimensional (3D) sensor, a motion sensor, a smoke sensor, a glass-break sensor, a door sensor, a window sensor, a carbon monoxide sensor, an accelerometer, a global positioning system (GPS) sensor, a Wi-Fi positioning system sensor, a capacitance sensor, a radio frequency sensor, a near-field sensor, a heartbeat sensor, a breathing sensor, an oxygen sensor, a carbon monoxide sensor, a brain waive sensor, a movement sensor, a voice sensor, and the like.

Controller 105 may include at least some processing or logic capability and provide communication with at least some of the sensors with which device 205 is in communication (e.g., barrier operation sensor 115). Although the components of device 205 are depicted as being internal to device 205, it is understood that one or more of the components may be external to the device 205 and connect to device 205 through wired and/or wireless connections. For example, one or more components (e.g., software, firmware, and/or hardware) of controller 105 may be located, installed, and/or a part of other components and/or systems of environment 200.

Device 205 may communicate with barrier 210 and alarm 215 via network 110. Network 110 may include cloud networks, local area networks (LAN), wide area networks (WAN), virtual private networks (VPN), wireless networks (using 802.11, for example), and/or cellular networks (using 3G or LTE, for example), etc. In some embodiments, the network 110 may include the Internet.

Barrier 210 may include, for example, any structure that controls entry through an access point into a building. For example, barrier 210 may include a door, window, covering, shield, or the like for any building structure. Barrier operation sensor 115 may be associated in some way with barrier 210. For example, barrier operation sensor 115 may be mounted directly to barrier 210. In other examples, barrier operation sensor 115 may be mounted adjacent to barrier 210. Barrier operation sensor 115 may be mounted to a feature of barrier 210 such as, for example, a latch, handle, lock mechanism, hinge, or the like. Barrier operation sensor 115 may be configured as an add-on device that is mounted to a barrier after construction and/or assembly of the barrier and its components. For example, the barrier operation sensor 115 may be mounted to an exterior surface (e.g., a door or window frame, or an outer surface of a latch, handle, hinge, or the like). Additionally, and/or alternatively, barrier operation sensor 115 may be mounted internal to a portion of barrier 210 (e.g., within a bore, recess, groove, or internal cavity of a portion of barrier 210). In this way, barrier operation sensor 115 may be retrofit to an existing barrier as an add-on feature that helps determine operation of barrier 210.

Additionally, or alternatively, barrier operation sensor 115 may be integrated into one or more portions of barrier 210. For example, barrier operation sensor 115 may be mounted within a structural component of barrier 210, assembled with electrical or mechanical components of a lock or latch mechanism mounted to the barrier, or positioned within a groove, bore, or the like that is pre-formed in the barrier so as to be mounted out of view and/or arranged in a finished condition along with other finished features of barrier 210.

In one example, a barrier 210 in the form of an exterior door of a building may have one or more barrier operation sensors 115 integrated therein prior to installation in the home. In another example, an existing barrier 210 (e.g., an existing exterior door of a building) is retrofit with one or more barrier operation sensors 115. For example, the barrier operation sensor 115 may be mounted to an existing door handle or latch, door lock feature, door hinge, or door frame. Providing barrier operation sensor 115 as a retrofit device may eliminate the need to replace and/or match existing hardware, décor, etc. of a where barrier 210 resides when using integrated latch/lock sensor components.

Alarm 215 may be activated or deactivated based at least in part on an operation status of barrier 210 that is determined using signals from barrier operation sensor 115 and/or output from barrier sensor module 120. In one example, barrier 210 includes at least one barrier operation sensor 115 that is operable to determine if a user is attempting to operate barrier 210 from either an interior side or an exterior side of barrier 210. Barrier operation sensor 115 sends signals associated with the user's operation of barrier 210 to device 205. Barrier sensor module 120 determines from which side of barrier 210 the user is operating barrier 210. Controller 105 may also operate to generate an alarm using alarm 215 depending on which side of barrier 210 the user is operating barrier 210.

In one example, controller 105 is typically programmed to generate an alarm via alarm 215 every time barrier 210 is operated. The alarm generated by alarm 215 may be, for example, an audible chime. The operator may program device 205 and/or controller 105 to only sound the chime generated by alarm 215 when people enter the building via barrier 210 from the outside, but not when someone exits the building via barrier 210 from the inside. Signals from barrier operation sensor 115 may be used by barrier sensor module 120 to determine from which side barrier 210 is operated and then control generation of the alarm from alarm 215 based on that determination.

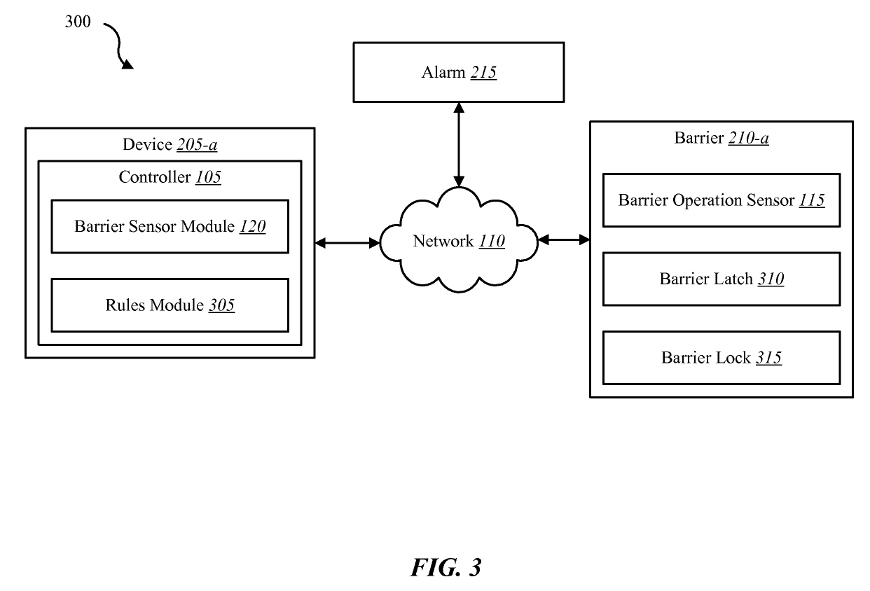

FIG. 3 is a block diagram illustrating one embodiment of an environment 300 in which the present systems and methods may be implemented. Environment 300 may include at least some of the components of environments 100, 200 described above. Environment 300 may include a device 205 having a controller 105-a with barrier sensor module 120 and a rules module 305. Barrier 210-a may include barrier operation sensor 115 as well as a barrier latch 310 and a barrier lock 315. Device 205-a communicates with barrier 210-a and alarm 215 via network 110. As described above, network 110 may provide wireless and/or wired communication between various components of environment 300.

Rules module 305 may include a plurality of rules and/or conditions for operation of components of environment 300. For example, rules module 305 may control operation of alarm 215 based in part on output from barrier sensor module 120 related to which side barrier 210-a is operated from. Rules module 305 may generate and/or implement a variety of rules for controlling other components of environment 300 such as, for example, one or more sensors, lighting, HVAC equipment and controls, appliances, electronics, computing devices, cameras, motion detection equipment, and the like. At least some of the rules determined by or operated using rules module 305 may be based at least in part on operation of barrier 210-a, such as from which side of barrier 210-a the barrier is operated.

In one example, rules module 305 may automatically turn ON (arm) a security system if it is determined that barrier 210-a is operated from an interior side between the hours of 7:00 a.m. and 7:30 a.m. on a weekday when past behavior of a user indicates that this is the time he departs for work outside the home. In another scenario, rules module 305 may turn ON exterior lighting, turn down a thermostat setting, and lock exterior doors when it is determined that barrier 210-a is operated from an exterior side between the hours of 10:00 p.m. and 11:00 p.m. (e.g., when the user is returning home for the night).

Barrier operation sensor 115 may be associated with barrier latch 310 and/or barrier lock 315 of barrier 210-a. For example, barrier operation sensor 115 may indicate when barrier latch 310 and/or barrier lock 315 is operated from either an interior side or an exterior side of barrier 210-a. The information from barrier operation sensor 115 may be delivered to barrier sensor module 120 for determining from which side barrier 210-a is being operated. In one example, barrier operation sensor 115 operates independent of barrier latch 310 and/or barrier lock 315 to determine from which side barrier 210-a is being operated (e.g., the operation of barrier sensor module 120). If barrier 210-a is being operated from a particular side and other conditions are met (e.g., time of day, authentication of an authorized user, etc.), one of barrier latch 310 and barrier lock 315 may be operating in a way that prevents opening of barrier 210-a (e.g., maintaining barrier lock 315 in a locked state).

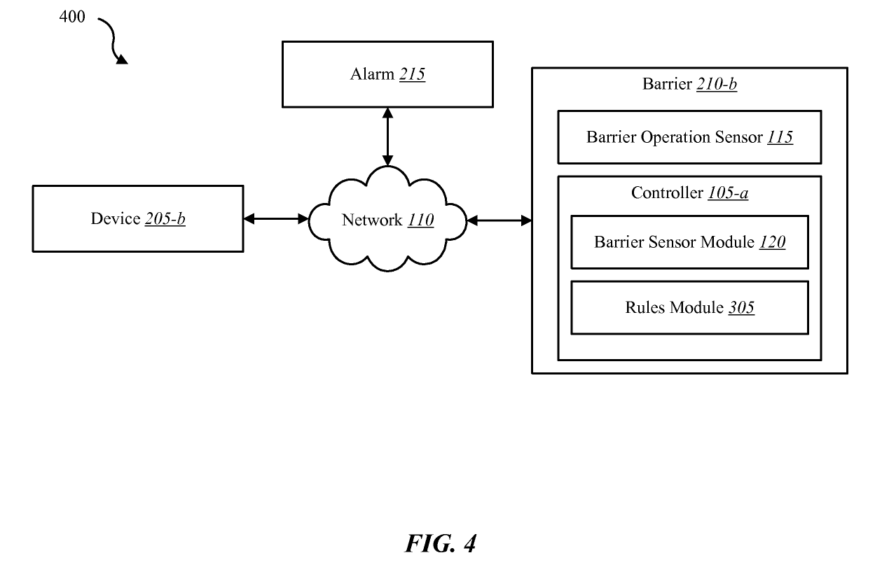

Referring now to FIG. 4, in some embodiments, an environment 400 may include at least some of the components of environments 100, 200, 300 described above, and may additionally include a device 205-b, a barrier 210-b, and an alarm 215 that communicate via a network 110. Barrier 210-b may include barrier operation sensor 115 and controller 105-a. Controller 105-a may include barrier sensor module 120 and rules module 305.

Environment 400 may represent one embodiment in which at least some processing and/or logic may be conducted at barrier 210-b rather than at another location such as on device 205 as described above. Information from barrier operation sensor 115 may be conveyed to barrier sensor module 120 for determining an operation condition of barrier 210-b (e.g., from which side barrier 210-b is being operated). Rules module 305 may or may not be included with controller 105-a. Rules module 305 may operate to control other features and/or components of environment 400 such as, for example, alarm 215. Rules module 305 may communicate with device 205-b to provide control of other components of environment 400, such as components of an automation system and/or security system.

Barrier operation sensor 115 and controller 105-a may be mounted to, located at, and/or positioned relative to barrier 210-b, or may be separately mounted and/or positioned relative to barrier 210-b. In at least one example, barrier operation sensor 115 and controller 105-a may be housed in a common housing and mounted at a common location relative to barrier 210-b.

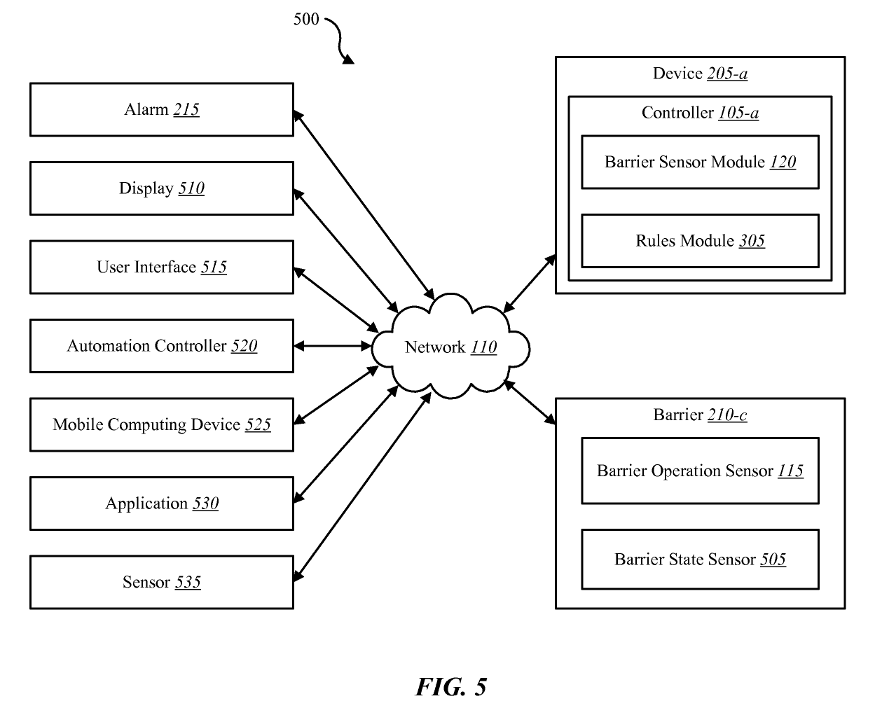

Referring now to FIG. 5, in some embodiments, an environment 500 may include at least some of the components of environments 100, 200, 300, 400 described above, and they further include a barrier state sensor 505 associated with barrier 210-c, a display 510, a user interface 515, an automation controller 520, a mobile computing device 525, an application 530, and a sensor 535. Environment 500 may further include device 205-a having controller 105-a with barrier sensor module 120 and rules module 305.

Alarm 215 may provide an audible sound, lights, or the like that provide communication with one or more users on the premises being monitored, or communications with a remote device or system related to a condition of the property being monitored. Alarm 215 may be integrated into display 510 in the form of, for example, text, color displays, or the like.

Barrier operation sensor 115 may provide signals that are used by barrier sensor module 120 to determine from which side barrier 210-c is operated. Barrier state sensor 505 may determine an open or closed state for barrier 210-c. Barrier state sensor 505 may be mounted at a different locations relative to barrier 210-c. For example, barrier state sensor 505 may be mounted to or associated with a hinge or a door frame surrounding barrier 210-c, while barrier operation sensor 115 is mounted to or associated with, for example, a latch or lock of barrier 210-c. In at least some embodiments, barrier sensor module 120 confirms that the barrier 210-c is in a closed state via feedback from barrier state sensor 505 before attempting to determine from which side barrier 210-c is being operated via feedback from barrier operation sensor 115.

Display 510 may include, for example, a digital display as part of, for example, a control panel of device 205-a. Display 510 may be provided via devices such as, for example, a desktop computer or mobile computing device 525. User interface 515 may be integrated into display 510. User interface 515 may include a plurality of menus, screens, microphones, speakers, cameras, and other capabilities that permit interfacing with the user of environment 500 generally or, for example, with device 205-a. User interface 515 may be integrated into mobile computing device 525 or other devices.

Automation controller 520 may provide features and functionality related to automation and/or security features of environment 500 (e.g., device 205-a). Automation controller 520 may provide at least some of the logic, processing, and/or interaction among various components of environment 500 and may include, for example, controller 105-a. Mobile computing device 525 may include a mobile application that interfaces with one or more functions of other components shown in environment 500. Examples of automation controller 520 may include a dedicated home automation computing device (e.g., wall-mounted controller), a personal computing device (e.g., laptop, desktop, etc.), a mobile computing device (e.g., tablet computing device, smart phone, etc.), and the like.

In some embodiments, mobile computing device 525 may include one or more processors, one or more memory devices, and/or a storage device. Examples of mobile computing device 525 may include DVRs, personal video recorders (PVRs), and/or mobile computing devices, smart phones, personal computing devices, computers, servers, etc.

Application 530 may allow a user to control (either directly or via automation controller 520) an aspect of the monitored property, including security, energy management, locking or unlocking a door, checking the status of a door, locating the user or item, controlling lighting, thermostats, or cameras, receiving notifications regarding a current status or anomaly associated with a home, office, place of business, and the like. In some configurations, application 530 may enable device 205-a to interface with automation controller 520 and utilize user interface 515 to display automation, security, and/or energy management content on display 510, user interface 515, mobile computing device 525, or other features of environment 500 and/or device 205-a. Thus, application 530, via user interface 515, may allow users to control aspects of their home, office, and/or other type of property. Further, application 530 may be installed on mobile computing device 525 in order to allow user to interface with a function of the components shown in environment 500 (e.g., device 205-a), such as components of a home automation and/or home security system.

Sensor 535 may represent one or more separate sensors or a combination of two or more sensors in a single sensor device. For example, sensor 535 may represent one or more camera sensors and one or more motion sensors connected to environment 500. Additionally, or alternatively, sensor 535 may represent a combination sensor such as both a camera sensor and the motion sensor integrated into the same sensor device. Additionally, or alternatively, sensor 535 may be integrated into a home appliance or a fixture such as a light bulb fixture and/or the barrier 210-c. Sensor 535 may include an accelerometer to enable sensor 535 to detect a movement. Sensor 535 may include a wireless communication device, enabling sensor 535 to send and receive data and/or information to and from one or more devices in environment 500. Additionally, or alternatively, sensor 535 may include a GPS sensor to enable sensor 535 to track a location of sensor 535. Sensor 535 may include a proximity sensor to enable sensor 535 to detect proximity of a user relative to a predetermined distance from a dwelling (e.g., geo-fencing). Sensor 535 may include one or more security detection sensors such as, for example, a glass break sensor, a motion detection sensor, or both. Additionally, or alternatively, sensor 535 may include a smoke detection sensor, a carbon monoxide sensor, or both. In at least some examples, sensor 535 may detect presence of a user within a dwelling being monitored by components of environment 500, performing certain functions (e.g., opening a door or window), or speaking a voice command. Sensor 535 may be integrated into or used in place of either one of barrier operation sensor 115 and barrier state sensor 505 and other sensors associated with barrier 210-c.

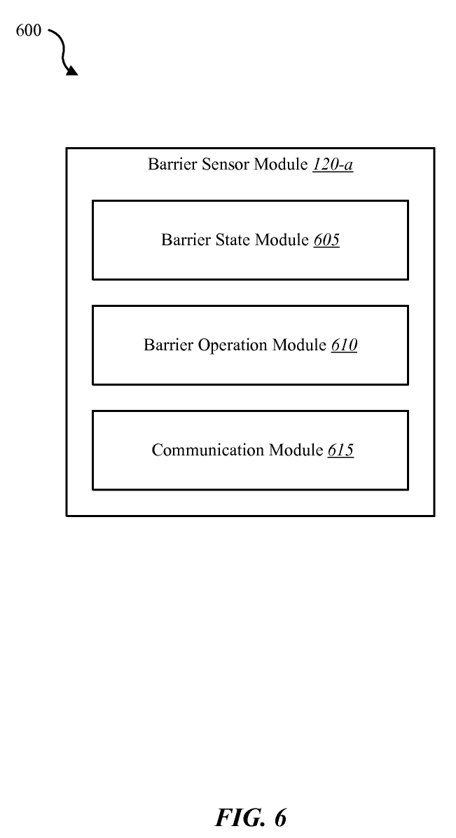

FIG. 6 shows a block diagram of an example barrier sensor module 120-a that may be one example of the barrier sensor module 120 shown in FIGS. 1-5. Barrier sensor module 120-a may include a barrier state module 605, a barrier operation module 610, and a communication module 615. Barrier state module 605 may receive sensor signals from, for example, barrier state sensor 505 of barrier 210-c shown in FIG. 5. Barrier state module 605 may use sensor signals from barrier state sensor 505 to determine an open or closed state of the barrier 210.

Barrier operation module 610 may receive sensor signals from barrier operation sensor 115 of barrier 210 shown in FIGS. 1-5 to assist in determining from which side the barrier 210 is being operated. Communication module 615 may provide one-way or two-way communication with the barrier operation sensor 115 and barrier state sensor 505, as well as other sensors associated with barrier 210. Communication module 615 may transmit instructions for operation of one or more components of barrier 210 such as, for example, a locking or latching device, or operation of any one of the sensors associated with barrier 210.

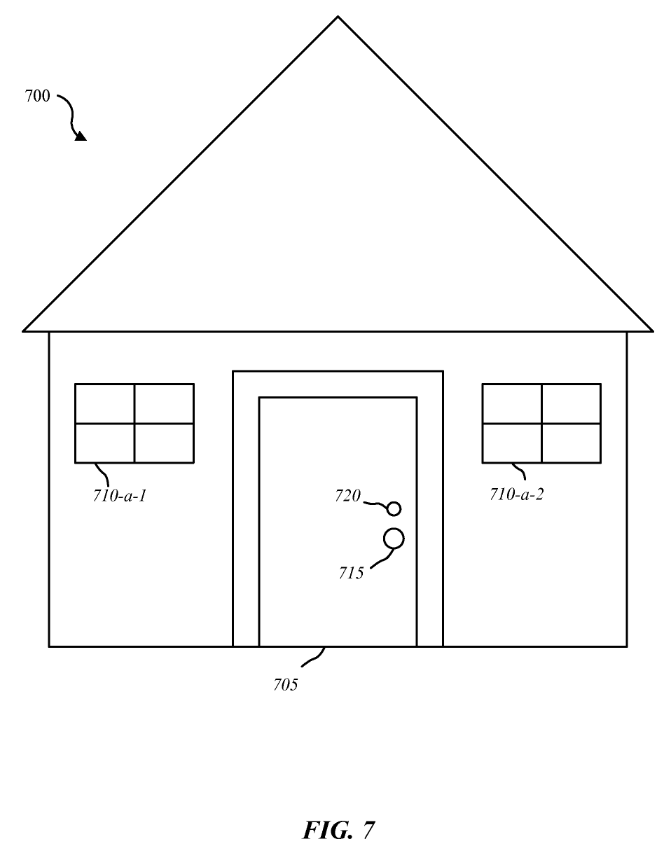

FIG. 7 illustrates schematically a home 700 wherein at least some of the features and functionality of the environments 100-500 described herein may be implemented. Home 700 includes a door 705, window 710-a-1 and 710-a-2, a door handle 715, and a door lock 720. Door 705 includes interior (not shown) and exterior (shown) sides. Either one of handle 715 and lock 720 may be operated from either the interior or exterior sides of door 705.

Windows 710 may be operated from either an interior or exterior side of home 700. Typically, window 710 includes a locking or latch feature positioned on the interior side. Home 700 may include at least one barrier operation sensor that provides feedback used to determine from which side door 705 and/or window 710 are operated as part of determining which direction a user is traveling relative to an access point into the home (e.g., entering or exiting).

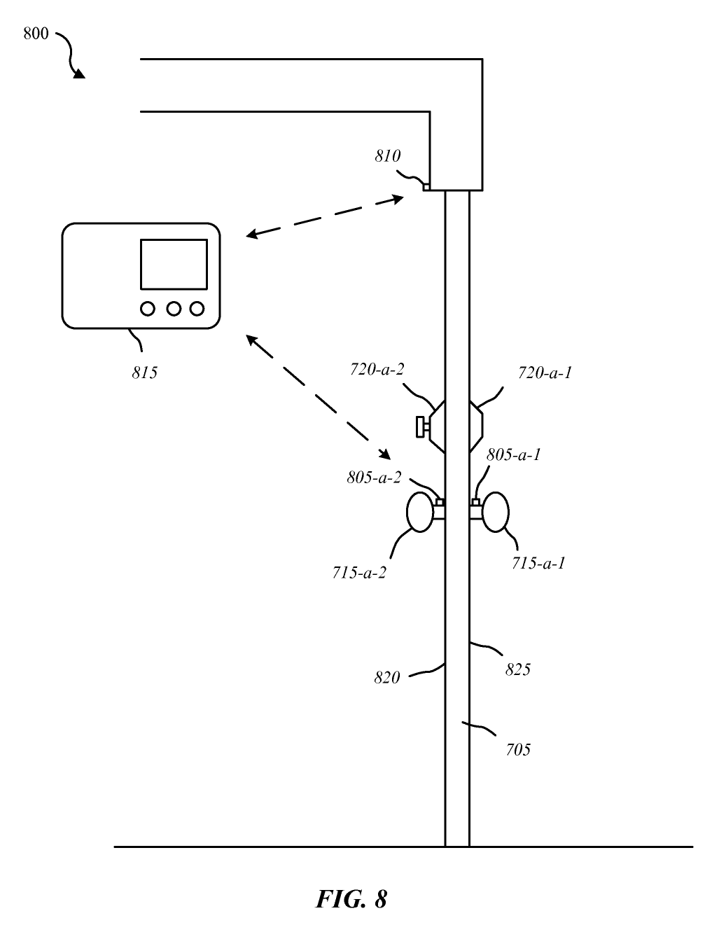

FIG. 8 shows a cross-sectional view 800 of a portion of home 700 shown in FIG. 7. View 800 includes, in addition to door 705, exterior and interior handles 715-a-1 and 715-a-2, interior and exterior locks 720-a-1 and 720-a-2, exterior and interior barrier operation sensors 805-a-1 and 805-a-2, a barrier state sensor 810, and a control panel 815 (e.g., device 205). Door 705 includes an interior side 820 and an exterior side 825.

Barrier operation sensors 805 may operate in a variety of ways using any number of different technologies to determine whether door 705 is being operated from an interior or exterior side. For example, barrier operation sensors 805 may include touch sensor features, wherein touching any portion of handle 715, lock 720, or a surface of door 705 on either the exterior or interior side of door 705 may generate a signal. The touch sensor may use, for example, electrostatic or electromagnetic technology to determine a touch event. Barrier operation sensor 805 may be directly connected to that portion of door 705, handle 715, or lock 720 that is touched in order to generate a touch signal. In at least one example, barrier operation sensor 805 may be directly mounted to an exterior, exposed surfaced of at least one of door 705, handle 715, and lock 720

In another example, barrier operation sensors 805 include an optical sensor. The optical sensor may operate to detect motion or otherwise detect the presence of an object. Optical sensors may be used in a variety of ways to determine either the presence of a user on one side or the other of the barrier, or actual operation of various features of the barrier. In one example, the optical sensor may be operable to determine the presence of a user directly adjacent to an interior or exterior surface of the barrier just prior to or after the barrier is operated from a closed state to an open state as determined by, for example, the barrier state sensor 810. In another example, the optical sensor determines movement of one of the handle 715 or lock 720, or components thereof. The optical sensor may be positioned on an exterior, exposed surface of a feature of the barrier (e.g., on a surface of door 705 and/or surface of handle 715 or lock 720).

In another example, a barrier operation sensors 805 may include a mechanical button or switch. The mechanical device may be coupled to one of handle 715 or lock 720 and be activated upon operation of the handle 715 or lock 720. In another arrangement, the mechanical device is intentionally and separately operated by a user in association with operating the barrier between open and closed positions. For example, a mechanical button may be positioned adjacent to a latch mechanism for a window. The user may be instructed to actuate the mechanical device prior to, after, or during operation of the window latch as part of opening the window. Operating the mechanical sensor may generate a signal that is used by the barrier sensor module to determine that no alarm is necessary because the window opening was authorized (e.g., opened from the interior side as indicated by operation of the mechanical sensor).

Many other types of sensor technology may be implemented in ways to determine operation of a barrier from either interior or exterior sides of the barrier. The touch, motion, optical, and mechanical sensor examples described herein are merely exemplary of the many possible sensor technologies that are available.

The signals generated by sensors 805, 810 may be transmitted wirelessly to a controller. FIG. 8 shows control panel 815 in communication with sensors 805, 810 using either wired or wireless communication. A control panel 815 may include at least controller 105 disclosed herein and the related barrier sensor module 120.

Additionally, or alternatively, the controller and associated barrier sensor module may be integrated into a common housing with one or more of the sensors 805, 810, and/or otherwise mounted in close proximity to the barrier (e.g., door 705).

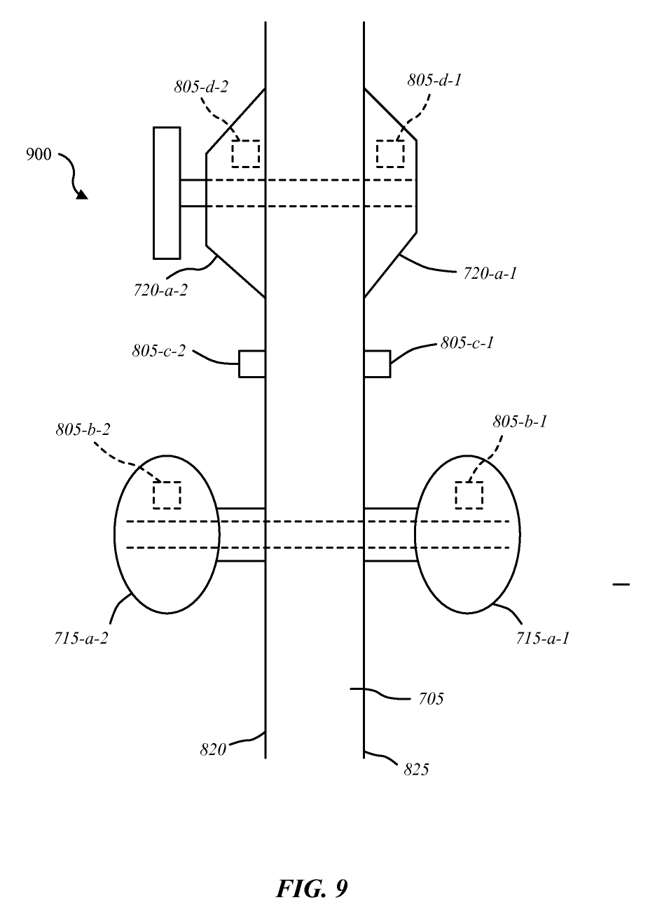

Referring to FIG. 9, another example barrier 900 is shown with sensors in alternative positions relative to features of the barrier (e.g., door 705). FIG. 9 shows barrier operation sensors 805-b-1 and 805-b-2 positioned internal the exterior and interior handles 715. FIG. 9 also shows barrier operation sensors 805-c-1 and 805-c-2 positioned on exterior and interior surfaces of door 705 rather than being mounted to any hardware (e.g., handles or locks) associated with door 705. FIG. 9 also shows barrier operation sensors 805-d-1 and 805-d-2 associated with internal locks 720 (e.g., either internally or externally mounted). The barrier operation sensors 805 shown with barrier 900 may utilize any one of the touch, motion, optical, and mechanical sensors described above with reference to FIG. 8, or any other type of sensor. The barrier operation sensor 805 may monitor internal and external components of barrier 900 and may communicate via wired or wireless communication channels. For example, sensors 805-d-1 and 805-d-2 may determine the presence of a key being inserted into the lock 720 and may separately determine rotation of the lock (e.g., multiple locking or unlocking steps). Any combination of the barrier operation sensors 805 shown in FIG. 9 and/or FIG. 8 may be used together on internal or external sides of the barrier.

The determination of which side a barrier is operated from may be used with other information to establish patterns of behavior for someone entering or leaving at particular times and/or days. Such patterns may be associated with real-time triggers and/or rules for control of an automation system for a given building. Pattern detection and rule generation/triggering may be particularly useful in “always ON” security and/or automation systems wherein the user identity, specific user location or activity, and the like contribute to successful and accurate prediction of what the user would want for the current state and operation of the automation system.

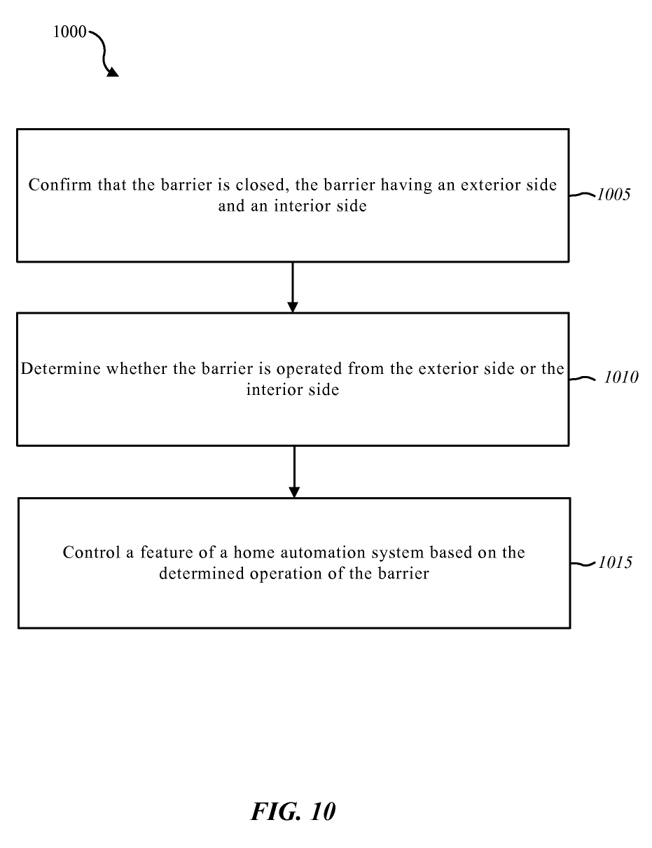

FIG. 10 is a flow diagram illustrating one embodiment of a method 1000 for determining operation of an openable barrier into a building. In some configurations, the method 1000 may be implemented by the barrier sensor module 120 of controller 105 shown in FIGS. 1-5. In other examples, method 1000 may be performed generally by controller 105 or device 205 shown in FIGS. 2, 3, 4 and/or 5, or even more generally by the environments 100, 200, 300, 400, 500 shown in FIGS. 1-5, respectively.

At block 1005, the method 1000 includes confirming that the barrier is closed, wherein the barrier has an exterior side and an interior side. At block 1010, method 1000 includes determining whether the barrier is operated from the exterior side or the interior side. Block 1010 includes controlling whether the barrier is permitted to open based on whether the barrier is operable from the exterior side or the interior side.

Method 1000 may include the barrier being one of a door or a window, and operating the barrier may include operating a handle or lock of the door or window. Determining whether the barrier is operated from the exterior side or the interior side may include operating at least one touch sensor, operating at least one motion sensor, operating at least one optical sensor, or operating at least one mechanical button or switch. The method 1000 may also include wirelessly transmitting a sensor signal from the barrier to a controller, and using the sensor signal to determine whether the barrier is operable from the exterior side or the interior side.

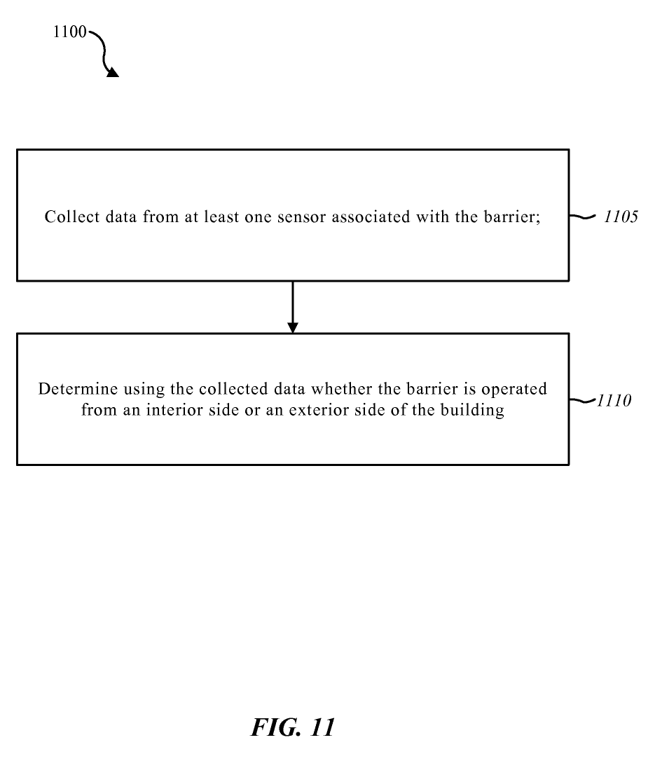

Referring to FIG. 11, a method 1000 is directed to a method for determining operation of an openable barrier into a building. In some configurations, the method 1100 may be implemented by the barrier sensor module 120 shown in FIGS. 1-5. In other examples, the method 1100 may be performed generally by controller 105 and/or device 205 shown in FIGS. 2-5, or even more generally by environments 100, 200, 300, 400, 500 shown in FIGS. 1-5, respectively.

At block 1105, method 1100 includes collecting data from at least one sensor associated with the barrier. Block 1110 includes determining using the collected data whether the barrier is operated from an interior side or an exterior side of the barrier.

Method 1100 may also include providing at least one handle or lock mounted to the barrier and operable to control opening of the barrier, and the sensor is configured to determine at least one operation state of the at least one handle or lock. The at least one sensor may include one of a touch sensor, a motion sensor, an optical sensor, and a mechanical button or a switch. The at least one barrier may be a door or a window. The method may include wirelessly transmitting signals from the at least one sensor to a control panel of an automation and security system. The method 1100 may include controlling opening of the barrier based on whether the barrier is operated from the interior side or the exterior side. Method 1100 may include generating an alarm if the barrier is operated from one of the interior side or the exterior side during an unauthorized time period. The method 1100 may include generating an alarm if the barrier is operated from one of the interior side or the exterior side, and by bypassing generating an alarm if the barrier is operated from the other of the interior side or the exterior side. The method 1100 may include determining whether the barrier is operated form an interior side or an exterior side of the building by determining if the user has touched the barrier. The method 1100 may include determining an identity of a user operating the barrier.

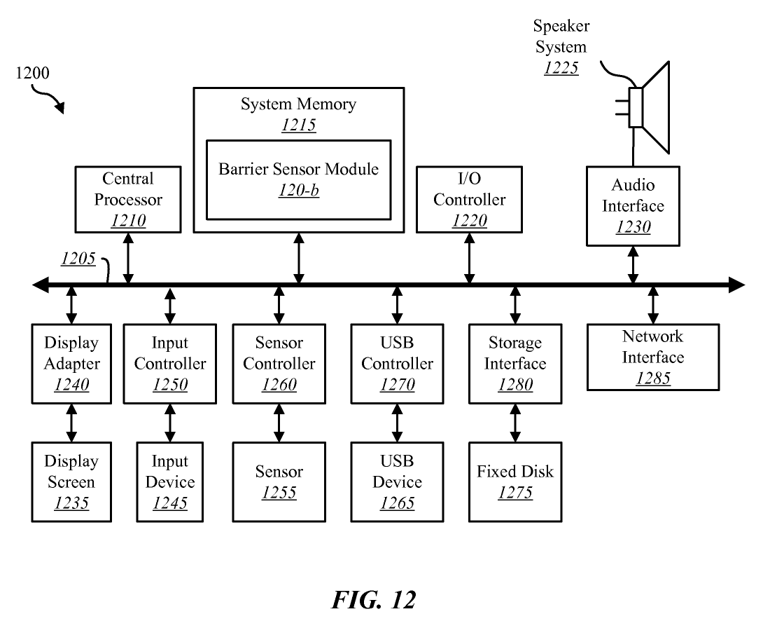

FIG. 12 depicts a block diagram of a controller 1200 suitable for implementing the present systems and methods. The controller 1200 may be an example of the controller 105 illustrated in FIGS. 1-5, and/or automation controller 520 illustrated in FIG. 5. In one configuration, controller 1200 includes a bus 1205 which interconnects major subsystems of controller 1200, such as a central processor 1210, a system memory 1215 (typically RAM, but which may also include ROM, flash RAM, or the like), an input/output controller 1220, an external audio device, such as a speaker system 1225 via an audio output interface 1230, an external device, such as a display screen 1235 via display adapter 1240, an input device 1245 (e.g., remote control device interfaced with an input controller 1250), multiple USB devices 1265 (interfaced with a USB controller 1270), and a storage interface 1280. Also included are at least one sensor 1255 connected to bus 1205 through a sensor controller 1260 and a network interface 1285 (coupled directly to bus 1205).

Bus 1205 allows data communication between central processor 1210 and system memory 1215, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, an barrier sensor module 120-b to implement the present systems and methods may be stored within the system memory 1215. The barrier sensor module 120-b may be an example of the barrier sensor module 120 illustrated in FIGS. 1, 2, 3, 4 and/or 5. Applications (e.g., application 530) resident with controller 1200 are generally stored on and accessed via a non-transitory computer readable medium, such as a hard disk drive (e.g., fixed disk 1275) or other storage medium. Additionally, applications can be in the form of electronic signals modulated in accordance with the application and data communication technology when accessed via interface 1285.

Storage interface 1280, as with the other storage interfaces of controller 1200, can connect to a standard computer readable medium for storage and/or retrieval of information, such as a fixed disk drive 1275. Fixed disk drive 1275 may be a part of controller 1200 or may be separate and accessed through other interface systems. Network interface 1285 may provide a direct connection to a remote server via a direct network link to the Internet via a POP (point of presence). Network interface 1285 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 1200 wirelessly via network interface 1285.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 12 need not be present to practice the present systems and methods. The devices and subsystems can be interconnected in different ways from that shown in FIG. 12. The aspect of some operations of a system such as that shown in FIG. 12 are readily known in the art and are not discussed in detail in this application. Code to implement the present disclosure can be stored in a non-transitory computer-readable medium such as one or more of system memory 1215 or fixed disk 1275. The operating system provided on controller 1200 may be iOS®, ANDROID®, MS-dOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A method for managing a barrier associated with a automation system, comprising:
confirming that the barrier is closed, the barrier having an exterior side and an interior side;
determining whether the barrier is operated from the exterior side or the interior side; and
controlling a feature of the automation system based at least in part on the determined operation of the barrier.

2. The method of claim 1, wherein the barrier is one of a door and a window, and operating the barrier includes operating a handle or lock of the barrier.

3. The method of claim 1, wherein determining whether the barrier is operated from the exterior side or the interior side includes operating at least one touch sensor.

4. The method of claim 1, wherein determining whether the barrier is operated from the exterior side or the interior side includes operating at least one motion sensor.

5. The method of claim 1, wherein determining whether the barrier is operated from the exterior side or the interior side includes operating at least one optical sensor.

6. The method of claim 1, wherein determining whether the barrier is operated from the exterior side or the interior side includes operating at least one mechanical button or switch.

7. The method of claim 1, further comprising:
wirelessly transmitting a sensor signal from the barrier to a controller of the automation system; and
using the sensor signal to determine whether the barrier is operated from the exterior side or the interior side.

8. The method of claim 1, further comprising:
controlling whether the barrier is permitted to open based at least in part on whether the barrier is operated from the exterior side or the interior side.

9. A sensor assembly for a barrier having an interior side and an exterior side, comprising:
at least one sensor configured to determine whether the barrier is operated from the interior side or the exterior side; and
a wireless transmitter configured to transmit signals from the at least one sensor to an automation and security system.

10. The sensor assembly of claim 8, wherein the at least one sensor comprises one of a touch sensor, an optical sensor, a motion sensor, a mechanical button, or a switch.

11. An apparatus for determining operation of a barrier associated with an automation system, comprising:
a processor;
a memory in electronic communication with the processor; and
instructions stored in the memory, the instructions being executable by the processor to:
collect data from at least one sensor associated with the barrier;
determine, using the collected data, whether the barrier is operated from an interior side or an exterior side of the barrier; and
control a feature of the automation system based at least in part on the determined operation of the barrier

12. The apparatus of claim 11, further comprising:
at least one handle or lock mounted to the barrier and operable to control opening of the barrier, the at least one sensor being configured to determine an operation state of the at least one handle or lock.

13. The apparatus of claim 11, wherein the at least one sensor includes one of a touch sensor, a motion sensor, an optical sensor, and a mechanical button or switch.

14. The apparatus of claim 11, wherein the barrier is a door or a window.

15. The apparatus of claim 11, wherein the instructions are executable by the processor to:
wirelessly transmit signals from the at least one sensor to a control panel of an automation and security system.

16. The apparatus of claim 11, wherein the instructions are executable by the processor to:
control opening of the barrier based at least in part on the whether the barrier is operated from the interior side or the exterior side.

17. The apparatus of claim 11, wherein the instructions are executable by the processor to:
generate an alarm if the barrier is operated from one of the interior side or the exterior side during an unauthorized time period.

18. The apparatus of claim 11, wherein the instructions are executable by the processor to:
generate an alarm if the barrier is operated from one of the interior side or the exterior side; and
bypass generating an alarm if the barrier is operated from the other of the interior side or the exterior side.

19. The apparatus of claim 11, wherein determining whether the barrier is operated from an interior side or an exterior side of the building includes determining if a user is touching the barrier.

20. The apparatus of claim 11, wherein the instructions are executable by the processor to:
determine an identity of a user operating the barrier.
